(19) United States
(12) Patent Application Publication
(10) Pub. No.: US 2006/0144200 A1
(43) Pub. Date: Jul. 6, 2006

(54) Cutting ring for disk rolls pertaining to partial and/or full cutting machines

(76) Inventor: Sandra Duden, Bottrop (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/541,546

(22) PCT Filed: Nov. 14, 2003
(86) PCT No.: PCT/EP03/12727

§ 371 Date: Jul. 1, 2005

(30) Foreign Application Priority Data
Jan. 29, 2003 (DE) 10300624.9

(51) Int. Cl. B26D 1/00

(52) U.S. Cl. 83/13

(57) ABSTRACT

The invention relates to a cutting ring (1) for disk rolls pertaining to partial and/or full cutting machines. Said cutting ring comprises a base ring (2) consisting of steel or a similar material, and a closed hard metal ring (3) which is arranged on the outer envelope (4) of the base ring (2) and is formed from a plurality of adjacently arranged hard metal partial segments (14) arranged on the outer envelope of the base ring (2), in the peripheral direction of the same. The aim of the invention is to create a high-quality, resistant cutting ring (1) at a comparatively low cost. To this end, the base ring (2) is divided into two axial sections (5, 6), an annular recess (11) for receiving the hard metal partial segments (14) is embodied between the radially outer sections of adjacent bearing surfaces (7, 8) of the axial sections (5, 6), and the two axial sections (5, 6) of the base ring (2) can be compressed with hard metal partial segments (14) inserted between the axial sections in the annular recess (11), by applying pressure, in order to form a solid composite.

The invention relates to a cutting ring for disk rolls of partial and/or full cutting machines, comprising a base ring made of steel or a similar material and a closed hard metal ring which is arranged on the outer envelope of the base ring and is formed from a plurality of adjacently arranged hard metal partial segments arranged on the outer envelop of the base ring, in the peripheral direction of the same, and to a method for producing a cutting ring of this type.

Cutting rings of this type are subjected to exceptionally high loads during the operation of the partial or full cutting machines. As a result, it is comparatively often necessary to replace these cutting rings with new ones, as a result of which high stoppage times occur in the actual advancing operation of the partial or full cutting machines which are accompanied by considerable economic disadvantages.

Thus, the object of the invention is to create a cutting ring for disk rolls of partial and/or full cutting machines which has a longer service life than the cutting rings known from the prior art and which, moreover, can be manufactured at a comparatively low cost.

According to the invention, this object is solved by a cutting ring which, in addition to the aforementioned features, is developed further in such a way that its base ring is divided into two axial sections, that an annular recess for receiving the hard metal partial segments is formed between the radially outer sections of adjacent bearing surfaces of these axial sections and that the two axial sections of the base ring can be compressed with hard metal partial segments inserted between the axial sections in the annular recess by applying pressure, in order to form a solid composite.

The annular recess for receiving the hard metal segments is advantageously formed by two partial annular recesses which are formed in the radially outer sections of the adjacent bearing surfaces of the two axial sections of the base ring. It is thereby ensured that the hard metal ring or the hard metal partial segments forming it protrude into both axial sections of the base ring.

Advantageously, the base ring should be divided axially in the centre into the two axial sections, a division of the annular recess into two halves on the two axial sections results inevitably from this. With this design, the hard metal ring or its hard metal partial segments can be connected with both axial sections of the base ring with the same quality.

To obtain a form-locking connection of adajcent hard metal partial segments of the hard metal ring, it is advantageous if each hard metal partial segment has, on its two face ends, a projection which protrudes in peripheral direction of the cutting ring.

If the projection protruding in peripheral direction is arranged on the one face end of the hard metal partial segment in a radially outer area of the face end and the projection protruding in peripheral direction on the other face end of the hard metal partial segment in a radially inner area of the face end, the hard metal ring consisting of hard metal partial segments having an identical shape can be put together. With this design of the individual hard metal partial segments, a load peak acting upon a hard metal partial segment of the hard metal ring is uniformly distributed on each of the hard metal partial segments adjacent to the hard metal partial segment acted upon and from there, further, so that a uniform absorption of load peaks on the hard metal ring and a transfer of such load peaks to the base ring takes place. As a result, the service life of the cutting ring can be considerably increased.

To produce an intimate connection between the hard metal partial segments, on the one hand, and the axial sections of the base ring, on the other hand, it is advantageous if the lateral surfaces of the hard metal partial segments are enlarged with respect to their surface by means of projections or grooves which are preferably triangular in cross section.

To reduce or compensate unavoidable differences in stress which result from the fact that the materials used for the base ring and for the hard metal ring are different, it is advantageous to provide a stress-compensating material layer, e.g. a nickel, chromium, chromium-nickel layer or the like, between the hard metal partial segments and the base ring.

Accordingly, it can be advantageous to also place a stress-compensating material layer, e.g. a nickel, chromium, chromium nickel layer or the like, between each of the adjacent hard metal partial segments.

The stress-compensating material layers can be advantageously formed by means of a foil.

According to an advantageous embodiment of the cutting ring according to the invention, each axial section of the base ring has an outer peripheral section which can be detached from it, preferably unscrewed, with which it protrudes beyond the outer periphery of the hard metal ring and by means of which, while interacting with a similarly designed outer peripheral section of the other axial section of the base ring, an annular space between the outer periphery of the hard metal ring and the two outer peripheral sections can be closed. As a result, a more or less closed space is created in the area of the annular recess forming the hard metal ring or hard metal partial segments forming the hard metal ring, it being possible to evacuate said space prior to producing the connection between the hard metal partial segments and the axial sections of the base ring, with the result that the probability of irregularities and weak spots is reduced during production of the composite.

With the method according to the invention for producing the cutting ring, the hard metal partial segments forming the hard metal ring are arranged on a radially outer section of a bearing surface of an axial section of the base ring in two axial sections, after which the other axial section of the base ring is joined with the hard metal partial segments forming the hard metal ring and an axial section thereof and the two axial sections compressed with the hard metal partial segments inserted between them to form a solid composite.

Advantageously, the hard metal partial segments forming the hard metal ring are hereby secured in an annular recess when the two axial sections of the base ring are joined together, said annular recess being formed in each half in the bearing surfaces of the two axial sections.

A resistance of the hard metal ring or cutting ring to radial forces occurring in the form of load peaks is obtained thereby that the hard metal partial segments engage in a form-locking manner on their face ends adjacent to one another.

The lateral surfaces of the hard metal partial segments may preferably be enlarged with respect to their surface by means of projections or grooves which are triangular in cross section.

As already mentioned above, a stress-compensating material layer, by means of which residual differences in stress are to be compensated, is provided between the axial sections of the base ring and the hard metal partial segments as well as between the adjacent hard metal partial segments. For this purpose, nickel, chromium, chromium nickel or the like are used, because these materials exhibit excellent stress compensating properties.

In an advantageous embodiment of the method according to the invention, the annular recess of the base ring receiving the hard metal partial segments of the hard metal ring is preferably closed by means of outer peripheral sections of the axial sections of the base ring radially protruding beyond the outer periphery of the hard metal ring, radially outside of the hard metal ring, and then evacuated by means of a suitable device. By this evacuation, the formation of defects on the connecting surfaces between the hard metal ring, on the one hand, and the base ring, on the other hand, and between the individual hard metal partial segments of the hard metal ring can be further reduced during production of the cutting ring.

The composite consisting of the two axial sections of the base ring and the hard metal partial segments is advantageously heated to a comparatively high temperature, which is however somewhat below the melting point of the material of the base ring, after the annular recess has been evacuated.

Advantageously, the composite consisting of the two axial sections of the base ring and the hard metal partial segments is then placed under high pressure using inert gas, preferably using argon, at which the flow limit of the base ring material is exceeded, namely preferably under a pressure of about 1,000 bar.

At this point, it is noted that both the temperature to which the composite is heated and the pressure with which the composite is then acted upon can depend on the type of material used for the base ring or hard metal ring and, optionally, also on the required profile for the quality of the cutting ring.

With these pressure and temperature conditions, the flow limit of the base ring material is exceeded, as a result of which an intimate connection between the base ring material and the lateral surfaces of the hard metal partial segments, which are provided with projections and grooves for this purpose, is attained since the base ring material enters into the grooves on the lateral surfaces of the hard metal partial segments.

After a preset period of time during which the high pressure and temperature below the melting point of the base ring material are maintained, the temperature is slowly lowered while maintaining the high pressure. As a result, the occurrence of stress peaks and differences in stress at the transition between the material forming the base ring and that forming the hard metal ring is avoided to a great extent. If required, remaining unavoidable residual differences in stress are compensated, as already noted, by the nickel foil.

The outer peripheral sections of the axial sections of the base ring can be advantageously removed after cooling.

The invention will be described in greater detail in the following with reference to an embodiment illustrated in the drawings, showing:

FIG. 1 an embodiment of a cutting ring according to the invention for disk rolls, in axial section;

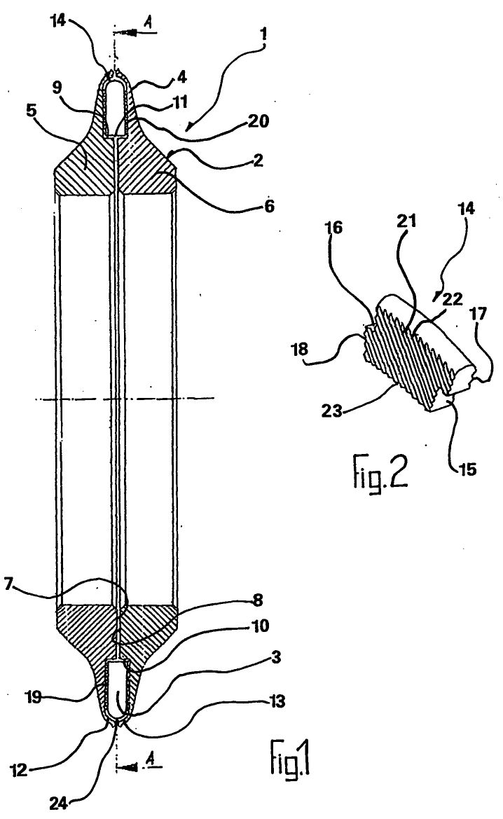

FIG. 2 a hard metal partial segment of the cutting ring according to the invention shown in FIG. 1 for disk rolls, in a perspective representation; and

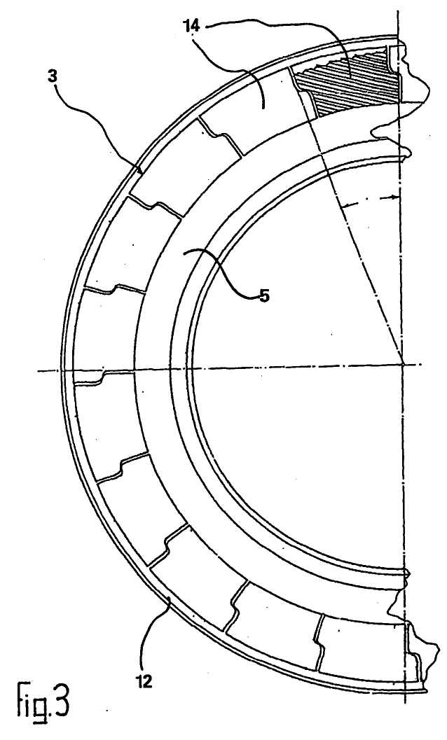

FIG. 3 an axial section of a base ring of the cutting ring according to the invention shown in FIG. 1 for disk rolls with hard metal partial segments inserted in it, in a radial view, wherein only one half of the axial section is shown.

A cutting ring 1, shown in an axial section in FIG. 1, for disk rolls of partial and or full cutting machines has a base ring 2 and a closed hard metal ring 3 which is situated on the outer envelope 4 of the base ring 2 or forms a part of the outer envelope of the cutting ring 1.

The base ring 2 of the cutting ring 1 according to the invention is divided into two axial sections 5, 6, the interface between the two axial sections 5, 6 of the base ring 2 being arranged axially in the centre in the base ring 2.

The two axial sections 4, 5 have bearing surfaces 7, 8 facing one another at which the two axial sections 5, 6 adjoin one another. A partial annular recess 9 or 10 each is formed in the radially outer sections of the two bearing surfaces 7, 8, the two partial annular recesses 9, 10 each extending along the entire outer periphery of the two axial sections 5, 6 or the two bearing surfaces 7, 8 and together forming an annular recess 11 for receiving the closed hard metal ring 3.

The two axial sections 5, 6 of the base ring 2 each have a peripherally extending outer peripheral section 12 or 13 which can be set together in such a way that the annular recess 11 can be locked on the outside by means thereof to receive the closed hard metal ring 3.

The two axial sections 5, 6 or the base ring 2 are made of steel or a material comparable thereto. A half of the annular recess 11 is formed in the radially outer sections of the adjacent bearing surfaces 7, 8 of the two axial sections 5, 6 by the two partial annular recesses 9, 10. The outer peripheral sections 12, 13 of the two axial sections 5, 6 can be subsequently separated from the axial sections 5, 6, for example, by an unscrewing process.

The hard metal ring 2 arranged in the annular recess 11 formed between the two axial sections 5, 6 of the base ring 2 is composed of a plurality of hard metal partial segments shown in a perspective view in FIG. 2. The hard metal ring 3 is formed in a closed design by means of the hard metal partial segments 14 each adjoining one another with their face ends 15, 16. Each hard metal partial segment 14 of the hard metal ring 3 has a projection 17 or 18 protruding in peripheral direction of the cutting ring 1 on each face end 15, 16, projection 17 being situated on the one face end 15 of the hard metal partial segment 14 on a radially inner section of the face end 15 and the projection 18 on the face end 16 of the hard metal partial segment 14 on a radially outer section of the face end 16. The individual hard metal partial segments 14 engage more or less in a form-locking manner due to the projections 17, 18 provided on their face ends 15, 16, so that a load of a hard metal partial segment 14 is distributed from it to the two adjacent hard metal partial segments 14, etc. As a result, a uniform load of the hard metal ring 3 is also produced when a single hard metal partial segment 14 must absorb a load peak.

On both lateral faces 19, 20, each hard metal partial segment 14 is designed with projections 21 and grooves 22 which are triangular in cross section to enlarge the surface of its lateral faces 19, 20. The triangular cross sectional shape is here only one of many feasible cross sectional shapes since, essentially, it is only important that the specific surface of the lateral faces 19, 20 of the hard metal partial segment 14 is enlarged.

To produce the cutting ring 1 of the invention in accordance with the method according to the invention, the hard metal partial segments 14 are inserted into the partial annular recess 9 of the one axial section 5 of the base ring 2, a stress-compensating material layer in the form of a nickel foil being placed between the lateral faces 19 and radially inner peripheral faces 23 of the hard metal partial segments 14. One half of an axial section 5 of the base ring 2 of this type provided with hard metal partial segments 14 is shown in FIG. 3. It is pointed out that all hard metal partial segments 14 are provided with the projections 21 and grooves 22 on their lateral faces 19, 20, this only being shown with reference to a hard metal partial segment 14 in FIG. 3. A stress-compensating material layer in the form of a nickel foil is also placed between the face ends 15, 16 of the hard metal partial segments 14 adjoining one another.

After all the hard metal partial segments 14 required for forming the closed hard metal ring 3 have been inserted into the partial annular recess 9 of the one axial section 5, the other axial section 6 of the base ring 2, also with insertion of a nickel foil in-between, is placed on the arrangement consisting of the axial section 5 and the hard metal partial segments 14.

As a result, a structure consisting of the two axial sections 5, 6 and the hard metal partial segments 14 as well as the nickel foils provided between the hard metal partial segments 14 and the one between the hard metal partial segments 14, on the one hand, and the two axial sections 5, 6, on the other hand, is formed.

The annular space 24 between the outer periphery of the hard metal partial segments 14 and the outer peripheral sections 12, 13 of the axial sections 5, 6 is now locked by connecting the two outer peripheral sections 12, 13 on their peripheral edges. This connection can be produced in any suitable manner. The closing of the annular space 24 is possible since the outer or peripheral edges of the two outer peripheral sections 12, 13 of the two axial sections 5, 6 extend radially outside of the free outer peripheral surface of the hard metal ring 3.

This annular space 24 is now evacuated by means of a suitable device.

After evacuating the annular space 24 or the annular recess 11, the structure or the composite consisting of the two axial sections 5, 6, the hard metal partial segments 14 and the nickel foils are heated to a comparatively high temperature which is below the melting point of the base ring material. This temperature can vary depending on the base ring material used.

After this temperature has been reached, the composite is placed under high pressure, which can e.g. be 1,000 bar, by using an inert gase, e.g. by using argon. It is important that the flow limit of the base ring material be exceeded at this pressure. With these pressure and temperature conditions, the base ring material flows into the grooves 22 of the lateral faces 19, 20 of the hard metal partial segments 14, as a result of which an intimate connection is produced between the base ring 2, on the one hand, and the hard metal ring 3, on the other hand. This preset period, as well as the temperature and pressure, depend on the material used for producing the cutting ring 1 and, optionally, also on the specific quality requirements of the cutting ring to be produced.

After this preset period, the composite consisting of base ring 2 and hard metal ring 3 is uniformly cooled, whereby the pressure does not change and remains high. The temperature is slowly lowered to avoid stress peaks and differences in stress. Residual differences in stress, which are unavoidable, are compensated by the nickel foils arranged between the hard metal partial segments 14 or between the hard metal partial segments 14 and the axial sections 5, 6.

The outer peripheral sections 12, 13 of the two axial sections 5, 6 can be easily unscrewed after the cutting ring 1 has been produced.

1. A cutting ring for disk rolls of partial and/or full cutting machines, comprising a base ring (2) made of steel or similar material and a closed hard metal ring (3) which is situated on the outer envelope (4) of the base ring (2), and a plurality of hard metal partial segments (14) arranged adjacent to one another in peripheral direction thereof on the outer envelope (4) of the base ring (2), characterized in that the base ring is divided into two axial sections (5, 6), that an annular recess (11) is formed between the radially outer sections of adjacent bearing surfaces (7, 8) of the axial sections (5, 6) for receiving the hard metal partial segments (14), and that the two axial sections (5, 6) of the base ring (2) can be compressed, by applying pressure, to form a solid composite with hard metal partial segments (14) inserted between them in the annular recess (11).

2. The cutting ring according to claim 1, wherein the annular recess (11) is formed by two partial annular recesses (9, 10), which are formed in the radially outer sections of the adjacent bearing surfaces (7, 8) of the two axial sections (5, 6) of the base ring (2), for receiving the hard metal partial segments (14).

3. The cutting ring according to claim 1, whose base ring (2) is divided axially in the centre into the two axial sections (5, 6).

4. The cutting ring according to claim 1, wherein each hard metal partial segment (14) has a projection (17, 18) protruding in peripheral direction of the cutting ring (1) on both of its end faces (15, 16).

5. The cutting ring according to claim 4, wherein the projection (17) protruding in peripheral direction on the one end face (15) of the hard metal partial segment (14) is arranged in a radially outer area of the end face (15) and the projection (18) protruding in peripheral direction of the other end face (16) of the hard metal partial segment (14) is arranged in a radially inner area of the end face.

6. The cutting ring according to claim 1, wherein the lateral faces (19, 20) of the hard metal partial segments (14) are enlarged with respect to their surface by means of projections (21) or grooves (22) which are preferably triangular in cross section.

7. The cutting ring according to claim 1 wherein a stress-compensating material layer, e.g. a nickel, chromium, chromium nickel layer or the like, is placed between the hard metal partial segments (14) and the base ring (2).

8. The cutting ring according to, wherein a stress-compensating material layer, e.g. a nickel, chromium, chromium nickel layer or the like, is placed between the adjacent hard metal partial segments (14).

9. The cutting ring according to claim 7, wherein the stress-compensating material layers are formed by means of a foil.

10. The cutting ring according to claim 1, wherein each axial section (5, 6) of the base ring (2) has an outer peripheral section (12, 13) which can be detached, preferably unscrewed, from it with which it protrudes beyond the outer periphery of the hard metal ring (3) and by means of which an annular space (24) between the outer periphery of the hard metal ring (3) and the two outer peripheral sections (12, 13) can be closed by interacting with a corresponding outer peripheral section (13) or (12) of the other axial section (6) or (5) of the base ring (2).

11. A method for producing a cutting ring (1) of partial and/or full cutting machines, wherein a base ring (2) made of steel or similar material is joined on its outer envelope (2) with a closed hard metal ring (3) consisting of a plurality of hard metal partial segments (14) arranged adjacent to one another in peripheral direction thereof on the outer envelope (4) of the base ring (2), characterized in that the hard metal partial segments (14) forming the hard metal ring (3) are arranged on a radially outer section of a bearing surface (7) of an axial section (5) of the base ring (2) divided into two axial sections (5, 6), that the other axial section (6) of the base ring (2) is joined together with the one axial section (5) thereof and the hard metal partial segments (14) forming the hard metal ring (3) and that the two axial sections (5, 6) are compressed with the hard metal partial segments (14) between them to form a solid composite.

12. The method according to claim 11, wherein the hard metal partial segments (14) forming the hard metal ring (3) are secured in an annular recess (11) when the two axial sections (5, 6) of the base ring (2) are joined together, each half of said annular recess (11) being formed in the bearing surfaces (7, 8) of the two axial sections (5, 6).

13. The method according to claim 11, wherein a composite of hard metal partial segments (14) which is resistant to radial forces is obtained thereby that the end faces (15, 16) of adjacent hard metal partial segments (14) engage in one another in a form-locking manner.

14. The method according to claim 11, wherein the lateral faces (19, 20) of the hard metal partial segments (14) are enlarged with respect to their surface by means of projections (21) or grooves (22) which are preferably triangular in cross section.

15. The method according to claim 11, wherein a stress-compensating material layer, e.g. a nickel, chromium, chromium nickel layer or the like, is arranged between the hard metal partial segments (14) and the axial sections (5, 6) of the base ring (2).

16. The method according to claim 11, wherein a stress-compensating material layer, e.g. a nickel, chromium, chromium nickel layer or the like, is arranged between the adjacent hard metal partial segments (14).

17. The method according to claim 15, wherein the stress-compensating material layer or the stress-compensating material layers is/are formed by a foil or foils.

18. The method according to claim 11, wherein the annular recess (11) of the base ring (2) receiving the hard metal partial segments (14) of the hard metal ring (3) is closed radially outside of the hard metal ring (3) and evacuated.

19. The method according to claim 18, wherein the annular recess (11) of the base ring (2) receiving the hard metal partial segments (14) of the hard metal ring (3) is closed by means of outer peripheral sections (12, 13), radially protruding beyond the outer periphery of the hard metal ring (3), of the axial sections (5, 6) of the base ring (2).

20. The method according to claim 17, wherein the composite consisting of the two axial sections (5, 6) of the base ring (2) and the hard metal partial segments (14) are heated to a high temperature which is below the melting point of the base ring material after the annular recess (11) has been evacuated.

21. The method according to claim 20, wherein, once it has been heated to the temperature below the melting point of the base ring material, the composite consisting of the two axial sections (5, 6) of the base ring (2) and the hard metal partial segments (14) is placed under a high pressure at which the flow limit of the base ring material is exceeded, preferably of about 1,000 bar using inert gas, preferably argon.

22. The method according to claim 21, wherein, after a preset period during which the high pressure and the temperature below the melting point of the base ring material have been maintained, the temperature is slowly lowered while the high pressure is maintained.

23. The method according to claim 19, wherein the outer peripheral sections (12, 13) of the axial sections (5, 6) of the base ring (2) are unscrewed after the cooling.
